(19) United States
(12) Patent Application Publication
(10) Pub. No.: US 2011/0034835 A1
(43) Pub. Date: Feb. 10, 2011

(54) Palm-held CPR helper medical device

(76) Inventor: Reid Evans, Graterford, PA (US)

Correspondence Address: Reid Evans;#AM-5261, P.O. Box 244, Graterford, PA, 19426-0244, US

(21) Appl. No.: 12/807,448

(22) Filed: Sep. 7, 2010

(51) Int. Cl. A61H 31/00

(52) U.S. Cl. 601/41

(57) ABSTRACT

The Palm-held CPR Helper Medical Device is a completely new medical device in the art of using CPR to help restart the heart muscle during cardiac arrest and it is only used the same way as in the compressing method used with hands-only CPR.

### BACKGROUND OF THE INVENTION

### Medical and Electronic fields

I, Reid Evans, had invented the new Palm-held CPR Helper Medical Device, as set forth in the following specification. The claimed CPR Helper is used to give more effective and safer CPR to a patient during cardiac arrest than hands-only compressing and defibrillation shocking to the heart muscle to restart it by sending a muscle contracting signal into it. The heart muscle works by contracting.

It is made similar to the Palm-held shocker toy that shocks a persons hand, when you shake hands with them and the Palm-held shot Excel that alerts you with an alarm, when the basketball touches the palm of your hand, while you are dribbling or shooting the basketball. And the CPR Helper is made by attaching a strap that goes around your hand to the round encasement housing unit, and you encase the battery; the computer-chip sensor; and the muscle contractor node into the encasement housing unit.

And the CPR Helper works by strapping it into the palm of your hand; putting conductive jell on the muscle contractor node; you start compressing the chest as you normally do, when performing CPR; and right at the point of complete compression, the muscle contractor node sends out a muscle contracting signal that is capable at that point of penetrating deep down into the chest and into the heart muscle, where it acts like the heart's sinoartial node, the heart's “Pacemaker,” sending a contracting signal, causing the heart to contract as it normally does. This mimicking of the heart contracting actions can stimulate the heart to restart and/or at least keep the blood flowing to the lungs to pick-up oxygen and circulate this oxygenated blood throughout the entire body to keep the patient alive during cardiac arrest.

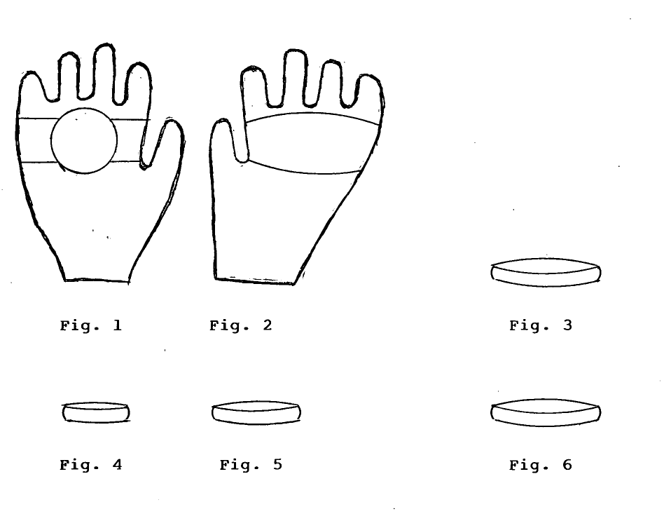

FIG. 1 is a palm of the hand view of how the CPR Helper fit into the palm of your hand, while you perform CPR.

FIG. 2 is a back of the hand view of how the strap of the CPR Helper fits around your hand to hold it in place.

FIG. 3 is a front view of the encasement housing unit that encases the battery; the computer-chip sensor; and the muscle contractor node.

FIG. 4 is a front view of the battery that powers the CPR Helper.

FIG. 5 is a front view of the computer-chip sensor that is programmed to turn on the power source and in turn the muscle contractor node, when it senses a certain amount of pressure on the muscle contractor node, so it can send the contracting signal into the chest and heart muscle right at the completed compression point. And it turns off the power and in turn the muscle contractor node after you let up on the chest compressions. This computer-chip sensor is the same or similar to the one in the Shot Excel that was mention earlier.

FIG. 6 is a front view of the Swisswave Technology muscle contractor node. This node is about the size of a silver dollar. And these are the same or similar muscle contractor nodes that are used in exercise equipment.

I claim:

1. The medical and electronic utility device called: “The Palm-held CPR Helper Medical. Device,” as described in the specification and as shown in the drawing disclosure within the Patent application.
